(19) United States
(12) Patent Application Publication
(10) Pub. No.: US 2026/0070603 A1
(43) Pub. Date: Mar. 12, 2026

(54) STEER-BY-WIRE SYSTEM HAVING ONE COMMON SHAFT FOR MULTIPLE MOTOR ASSEMBLIES

(71) Applicant: HL MANDO CORPORATION, Gyeonggi-do (KR)

(72) Inventor: Tony DODAK, Auburn, MI (US)

(21) Appl. No.: 19/315,654

(22) Filed: Sep. 1, 2025

Related U.S. Application Data
(60) Provisional application No. 63/692,007, filed on Sep. 6, 2024.

(51) Int. Cl. B62D 5/00; B62D 5/04

(52) U.S. Cl. CPC B62D 5/003; B62D 5/0421; B62D 5/049

(57) ABSTRACT

A steer-by-wire system may comprise: first and second motor assemblies having one common shaft; a single package having an inside space accommodating the first and second motor assemblies; a steering rack configured to be linearly movable in response to rotation of the one common shaft of the first and second motor assemblies; and a rotary-to-linear conversion mechanism operably connected between the one common shaft of the first and second motor assemblies and the steering rack and configured to convert a rotary motion of the one common shaft of the first and second motor assemblies into a linear motion for linearly moving the steering rack. A seal may be positioned between the first motor assembly and the second motor assembly in the inside space of the single package.

### CROSS REFERENCE TO RELATED PATENT APPLICATION(S)

This application claims the benefit of U.S. Patent Application Ser. No. 63/692,007, filed on Sep. 6, 2024, entitled “STEER-BY-WIRE SYSTEM”, which is all hereby incorporated by reference in its entirety.

### BACKGROUND

Various embodiments of the present disclosure generally relate to a steering system for a vehicle and more particularly to an apparatus and method for controlling a steer-by-wire system.

Vehicles require a steering system to control the direction of travel. Previously, mechanical steering systems have been used. The mechanical steering systems typically include a mechanical linkage or a mechanical connection between a steering wheel and vehicle's road wheels. For example, in a conventional steering system, which consists of a steering wheel, a steering column, a power assisted rack and pinion system, and tie rods, the driver turns the steering wheel which, through the various mechanical components, causes the road wheels of the vehicle to turn. Thus, movement of the steering wheel causes a corresponding movement of the road wheels. Movement of such mechanical systems is often power assisted through the use of hydraulic assists or electric motors.

The mechanical steering systems are expected to be replaced or supplemented by electrically driven steering systems, commonly known as “steer-by-wire” systems. Such steer-by-wire systems to varying extents replace, for example, the mechanical linkage between the steering wheel and the road wheels with one or more sensors, actuators and electronics. The steer-by-wire system aims to eliminate physical or mechanical connection between the steering wheel and vehicle wheels, and to change the direction of the vehicle wheels and provide feedback to a driver by using electrically controlled motors. Even though the mechanical linkage between the steering wheel and the road wheels has been eliminated, the steer-by-wire system is expected not only to produce the same functions and steering feel as a conventional mechanically linked steering system, but it is also expected to implement advanced steering system features. Requirements for conventional steering functions and advanced steering features such as adjustable steering feel can be implemented by an advanced control system design.

It is with respect to these and other general considerations that the following embodiments have been described. Also, although relatively specific problems have been discussed, it should be understood that the embodiments should not be limited to solving the specific problems identified in the background.

### SUMMARY

The features and advantages of the present disclosure will be more readily understood and apparent from the following detailed description, which should be read in conjunction with the accompanying drawings, and from the claims which are appended to the end of the detailed description.

According to various embodiments of the present disclosure, a steer-by-wire system may comprise: first and second motor assemblies having one common shaft operably coupled to a steering rack; and the steering rack configured to be linearly movable in response to rotation of the one common shaft of the first and second motor assemblies.

The first motor assembly may comprise a first rotor, a first stator, and a first circuit, the second motor assembly comprises a second rotor, a second stator, and a second circuit, and both the first rotor of the first motor assembly and the second rotor of the second motor assembly are fixedly coupled to the one common shaft operably coupled to the steering rack.

The steer-by-wire system may further comprise a single package having an inside space accommodating the first and second motor assemblies, wherein a seal is positioned between the first motor assembly and the second motor assembly in the inside space of the single package.

The steer-by wire system may further comprise a rotary-to-linear conversion mechanism operably connected between the one common shaft of the first and second motor assemblies and the steering rack and configured to convert a rotational motion of the one common shaft of the first and second motor assemblies into a linear motion for linearly moving the steering rack.

The steer-by wire system may further comprise a belt rotatably coupled to the one common shaft of the first and second motor assemblies and the rotary-to-linear conversion mechanism.

The steer-by-wire system may further comprise at least two belts arranged in parallel with each other and coupled to the one common shaft of the first and second motor assemblies and the rotary-to-linear conversion mechanism.

The steer-by-wire system may further comprise a flange between the at least two belts coupled to the one common shaft of the first and second motor assemblies such that the at least two belts are positioned to be spaced apart from each other.

The steer-by-wire system may further comprise a belt and a first gear coupled to the one common shaft of the first and second motor assemblies.

The steer-by wire system further comprise a second gear configured to maintain clearance between teeth of the first gear and teeth of the second gear in a state that the belt does not fail and to be engaged with the first gear to be rotated by the first gear coupled to the one common shaft of the first and second motor assemblies in a state that the belt fails.

The first motor assembly may comprise a first inductive motor position sensor configured to sense an angular position of a first motor of the first motor assembly, and the second motor assembly may comprise a second inductive motor position sensor configured to sense a position of a second motor of the second motor assembly.

The first motor assembly may comprise a first inductive motor position sensor configured to sense an angular position of a first motor of the first motor assembly, and the second motor assembly may comprise a second magnetic motor position sensor configured to sense a position of a second motor of the second motor assembly.

The steering-by-wire system may further comprise a linear position sensor configured to sense a linear position of the steering rack and connected to one or both of the first circuit of the first motor assembly and the second circuit of the second motor assembly.

The first rotor and the first stator of the first motor assembly and the second rotor and the second stator of the second motor assembly may be disposed between the first circuit of the first motor assembly and the second circuit of the second motor assembly.

The first rotor and the first stator of the first motor assembly may be disposed between the seal and between the first circuit of the first motor assembly, and the second rotor and the second stator of the second motor assembly may be disposed between the seal and between the second circuit of the second motor assembly.

This Summary is provided to introduce a selection of concepts in a simplified form that are further described below in the Detailed Description. This summary is not intended to identify key features or essential features of the claimed subject matter, nor is it intended to be used to limit the scope of the claimed subject matter.

### BRIEF DESCRIPTION OF THE DRAWINGS

Various embodiments in accordance with the present disclosure will be described with reference to the drawings, in which:

FIG. 1 is a schematic view of a vehicle including a steer-by-wire system according to an exemplary embodiment of the present disclosure;

FIGS. 2-4 are schematic views for illustrating a steer-by-wire system according to exemplary embodiments of the present disclosure.

FIG. 5 is a partial cross-sectional view of a steer-by-wire system according to an exemplary embodiment of the present disclosure.

Corresponding numerals and symbols in the different figures generally refer to corresponding parts unless otherwise indicated. The figures are drawn to clearly illustrate the relevant aspects of the embodiments and are not necessarily drawn to scale.

### DETAILED DESCRIPTION OF EMBODIMENTS

In the following detailed description, reference is made to the accompanying drawings which form a part of the present disclosure, and in which are shown by way of illustration specific embodiments in which the invention may be practiced. These embodiments are described in sufficient detail to enable those skilled in the art to practice the invention, and it is to be understood that other embodiments may be utilized and that structural, logical and electrical changes may be made without departing from the spirit and scope of the invention. The following detailed description is therefore not to be taken in a limiting sense, and the scope of the invention is defined only by the appended claims and equivalents thereof. Like numbers in the figures refer to like components, which should be apparent from the context of use.

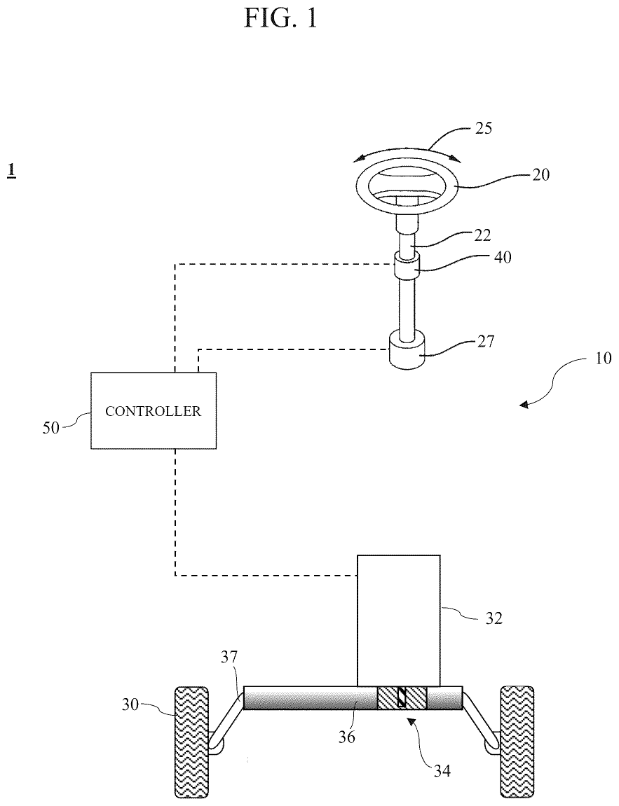

Referring now to FIG. 1, a steer-by-wire system 10 for use in a vehicle 1 is illustrated. In a conventional automotive steering system such as an electric power steering (EPS) system, a steering wheel is mechanically linked to one or more road wheels (e.g. front road wheels). However, the steer-by-wire system 10 according to an embodiment of the present disclosure removes this mechanical connection and instead, electronically controls a steering angle of road wheels 30 based on measurement of a steering wheel or hand wheel 20 and/or one or more control signals of a controller 50 and provides feedback to a driver or operator of the vehicle 1 using a plurality of actuators such as electric motors. Further, in the steer-by-wire system 10, the steering angle of road wheels 30 can be controlled by one or more control signals generated by an autonomous driving system or an advanced driver assistance system (ADAS) and/or generated by the controller 50 based on data from one or more sensors.

The steer-by-wire system 10 allows the driver or operator of the vehicle 1 to control the direction of the vehicle 1 or road wheels 30 of the vehicle 1 through the manipulation of the steering wheel 20. The steering wheel 20 is operatively or mechanically coupled or fixed to a steering shaft (or steering column) 22. The steering wheel 20 may be directly or indirectly connected with the steering shaft 22. For example, the steering wheel 20 may be connected to the steering shaft 22 through a gear, a shaft, a belt and/or any connection means. Alternatively, the steering wheel 20 may be fixed to the steering shaft 22. The steering shaft 22 may rotate together with the steering wheel 20.

One or more steering wheel sensors 40 may be configured to detect position, angular displacement or travel 25 of the steering shaft 22 or steering wheel 20, as well as detect the torque of the angular displacement or travel 25 of the steering shaft 22 or steering wheel 20. The steering wheel sensor 40 provides electric signals to the controller 50 indicative of the angular displacement and/or torque 25. The controller 50 sends and/or receives signals to and/or from an upper actuator 27 (e.g., a steering feedback actuator having an electric motor) to actuate the upper actuator 27 in response to the angular displacement and/or torque 25 of the steering wheel 20. The upper actuator 27 rotates or moves the steering wheel 20 to provide feedback to the driver or operator (similarly to the feedback provided by the wheels in a manual steering vehicle) in response to the control signals received from the controller 50.

In the steer-by-wire system 10, the steering wheel 20 may be mechanically isolated from the road wheels 30. Accordingly, the steer-by wire steering system 10 needs to provide the driver or operator with the same “road feel” that the driver receives with a direct mechanical link. Furthermore, it is desirable to have a device that provides a mechanical back up “road feel” in the event of multiple electronic failures in the steer-by-wire system. In addition, a device that provides positive on-center feel and accurate torque variation as the handwheel is rotated is also desirable. Therefore, the vehicle 1 may comprise the upper actuator 27 (e.g. steering feedback actuator).

The upper actuator 27 may comprise, for example, but no limited to, an electric motor which is connected to the steering shaft or steering column 22. For example, a gear or belt assembly may connect an output of the steering feedback actuator 27 to the steering shaft 22. Alternatively, the steering feedback actuator 27 may be directly coupled to the steering shaft 22 or the hand wheel 20. The steering feedback actuator 27 is actuatable to provide resistance to rotation of the steering wheel 20. The controller 50 is electrically coupled with the sensors 40 and to the steering feedback actuator 27. The controller 50 receives signals indicative of the applied torque and angular rotation 25 of the steering wheel 20 from the sensors 40. In response to the signals from the sensors 40, the controller 50 generates and transmits a signal corresponding to the sensed torque and angular rotation of the steering wheel 20 sensed by the sensors 40 and the steering feedback actuator 27 generates resistance torque to the rotation of the steering wheel 20 in response to the signal of the controller 50 to provide the steering feel to the driver.

The controller 50 also transmits signals or commands to a lower actuator 32 (e.g. a road wheel actuator). The lower actuator 32 controls the linear movement of a steering rack 36 in response to the control signals received form the controller 50. For example, the lower actuator 32 generates rotary motion in response to the control signals of the controller 50, and the rotary motion of the lower actuator 32 is converted into linear movement of the steering rack 36. Tie rods and knuckles 37 connect the steering rack 36 to road or vehicle wheels 30 and convert the linear movement of the steering rack 36 into rotation of the road wheels 30.

In use, the steering wheel 20 is angularly displaced 25 such that the steering shaft 22 can be also angularly displaced. The sensor 40 detects the angular displacement and torque 25 of the steering shaft 22 coupled with the steering wheel 20, and the sensor 40 sends signals to the controller 50 indicative of the relative amount of angular displacement and torque 25 of the steering shaft 22. The controller 50 sends control signals to the lower actuator 32 indicative of the relative amount of the angular displacement and/or toque of the steering shaft 22. In response, the lower actuator 32 moves the steering rack 36 so that the road wheels 30 are turned. Thus, the controller 50 controls the distance that the steering rack 36 is moved based on the amount of the angular displacement 25 of the steering wheel 20. Movement of the steering rack 36 manipulates the tie rods and knuckles 37 to reposition the road wheels 30 of the vehicle 1. Accordingly, when the steering wheel 20 is turned, the road wheels 30 are controlled to be turned.

In order to perform the prescribed functions and desired processing, as well as the computations therefore (e.g., the identification of motor parameters, control algorithm(s), and the like), the controller 50 may include, but not be limited to, a processor(s), computer(s), DSP(s), memory, storage, register(s), timing, interrupt(s), communication interface(s), and input/output signal interfaces, and the like, as well as combinations comprising at least one of the foregoing. For example, the controller 50 may include input signal processing and filtering to enable accurate sampling and conversion or acquisitions of such signals from communications interfaces. Although FIG. 1 illustrates the controller 50 as a single controller, one skilled in the art would understand that the controller 50 may be distributed among a plurality of vehicle controllers.

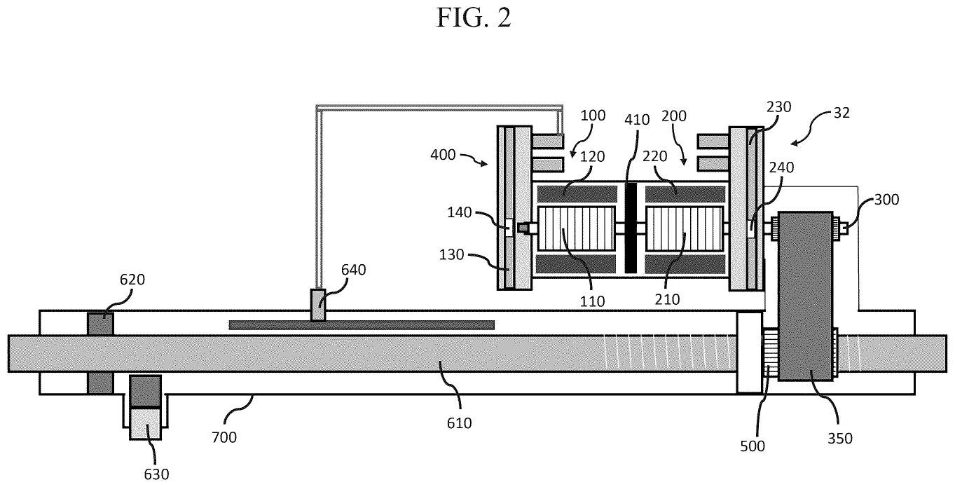

FIGS. 2-4 are schematic views for illustrating a steer-by-wire system according to exemplary embodiments of the present disclosure.

The lower actuator 32 (e.g. a road wheel actuator) may comprises a first motor assembly 100 and a second motor assembly 200 having one single common shaft 300.

A single package 400 has an inside space accommodating both the first motor assembly 100 and the second motor assembly 200 therein. A seal 410 is positioned between the first motor assembly 100 and the second motor assembly 200 so that each of the first motor assembly 100 and the second motor assembly 200 can be independently sealed.

The first motor assembly 100 may comprise a first rotor 110, a first stator 120, and a first circuit 130. The first rotor 110 is configured to be rotatable relative to the first stator 120. The first circuit 130. The first stator 120 is directly or indirectly coupled to a non-rotatable part of the single package 400. The first rotor and stator 110 and 120 are positioned between the seal 410 and the first circuit 130.

The second motor assembly 200 may comprise a second rotor 210, a second stator 220, and a second circuit 230. The second rotor 210 is configured to be rotatable relative to the second stator 220. The second stator 220 is directly or indirectly coupled to a non-rotatable part of the single package 400. The second rotor and stator 210 and 220 are positioned between the seal 410 and the second circuit 230.

The first rotor and stator 110 and 120 and the second rotor and stator 210 and 220 arranged to face each other such that the first rotor and stator 110 and 120 and the second rotor and stator 210 and 220 are disposed between the first circuit 130 and the second circuit 230.

The first and second circuits 130 and 230 may comprise any suitable circuitry and electronic components, such as a microprocessor, mounted thereon. The first and second circuits 130 and 230 may be configured to control the first and second motor assemblies 100 and 200, for example, but not limited to, supply power to the first and second motor assemblies 100 and 200, activate or deactivate the operation of the first and second motor assemblies 100 and 200, and vary the speed of the first and second rotors 110 and 210 and/or the rotational direction of the first and second rotors 110 and 210.

The first motor assembly 100 and the second motor assembly 200 has one single common shaft 300. For instance, both the first rotor 110 of the first motor assembly 100 and the second rotor 210 of the second motor assembly 200 are fixedly coupled to one single common shaft 300. Accordingly, the one single common shaft 300, the first rotor 110 of the first motor assembly 100, and the second rotor 210 of the second motor assembly 200 rotate together, and the one single common shaft 300 penetrates through the first rotor 110 of the first motor assembly 100, the second rotor 210 of the second motor assembly 200, and the seal 410.

The one single common shaft 300 is operably connected to a rotary-to-linear conversion mechanism 500.

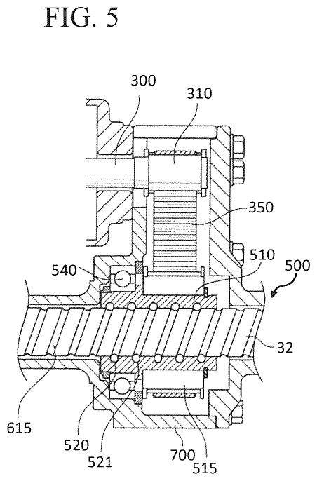

Referring to FIG. 5, a pulley 310 may be formed directly on the one single common shaft 300 or attached to the one single common shaft 300. The pulley 310 may have an outer surface that engages an inner surface of a belt 350. The pulley 310 of the one single common shaft 300 is rotatably connected to the rotary-to-linear conversion mechanism 500. The first motor assembly 100 and/or the second motor assembly 200 provide a rotary torque force to the pulley 310 via the one single common shaft 300. The rotation force of the pulley 310 is transferred to the belt 350. As the torque force is applied to the belt 350, the rotational force of the one single common shaft 300 is transferred to the rotary-to-linear conversion mechanism 500.

The rotary-to-linear conversion mechanism 500 (such as a nut-screw mechanism and a ball nut-screw mechanism) may be configured to convert rotary motion transferred from the one single common shaft 300 of the first motor assembly 100 and the second motor assembly 200 through the belt 350 into linear motion in order to linearly move the steering rack 36. The rotary-to-linear conversion mechanism 500 may include a rotatable part 510. For example, the rotatable part 510 may comprise a nut or a ball nut, although not required. At least a part of the steering rack 36 is retained within the rotatable part 510. The rotatable part 510 has an internally-threaded track groove 521 and at least a part of the steering rack 36 has an externally-threaded track groove 615 for a rotatable body arrangement of rotatable bodies 520 (e.g. balls). The rotatable bodies 520 are disposed between the internally-threaded track groove 521 of the rotatable part 510 and the externally-threaded track groove 615 of the steering rack 36. The rotatable bodies 520 may be metal spheres which decrease friction and transfer loads between adjacent components. The rotatable part 510 is rotatably supported by the steering rack 36 via the rotatable bodies 520 and a bearing assembly 540. However, in alternative embodiments of the present disclosure, the internally-threaded track groove 521 of the rotatable part 510 and the externally-threaded track groove 615 of the steering rack 36 can be directly engaged with each other without the rotatable bodies 220.

The bearing assembly 540 is configured to rotatably support the rotary-to-linear conversion mechanism 500. The bearing assembly 540 may be positioned between the rotatable part 510 and a non-rotating structure, for example, but not limited to, a housing 700. The bearing assembly 540 is used to rotatably support the rotatable part 510 for rotation relative to a non-rotating structure.

The pulley 310 of the one single common shaft 300 and the rotatable part 510 of the rotary-to-linear conversion mechanism 500 are rotatably connected to each other via the belt 350. The configuration of the belt 350 allows an inner engagement surface of the belt 350 to wrap around and engage both the pulley 310 of the one single common shaft 300 and a ball-screw pulley 515 that is fixed to the rotatable part 510. The rotational movement of the pulley 310 of the one single common shaft 300 causes rotation of the rotatable part 510 of the rotary-to-linear conversion mechanism 500, and then the rotary motion of the rotatable part 510 of the rotary-to-linear conversion mechanism 500 is converted into the linear motion of the steering rack 36 by the rotary-to-linear conversion mechanism 500.

A travel stop and rack support 620 is configured to limit the linearly movable range of the steering rack 36 and support the steering rack 36. The travel stop and rack support 620 provides stop positions which limit the travel of the steering rack 36 and, thus, limits the linear movement of the steering rack 36, thereby preventing the steering rack 36 from exceeding linear movement limits.

An anti-rotation support 630 is configured to limit the rotation of the steering rack 36 in order to prevent the steering rack 36 from rotating relative to a non-rotating structure, for example, but not limited to, the housing 700. For example, the anti-rotation support 630 includes a preloaded roller or a rotatable rack shoe and the steering rack 36 has a flat surface or a shape corresponding to a shape of the anti-rotation support 630 so that the steering rack 36 is slidable while unable to rotate. A part of the steering rack 36 has a substantially D shape having a flat surface to be operably associated with the anti-rotation support 630. Alternatively, the steering rack 36 has a groove (or a protrusion) which is keyed to a protrusion (or a groove) of the anti-rotation support 630 to restrict the rotary movement of the steering rack 36.

A first motor position sensor 140 and a second motor position sensor 240 are responsive to the rotation of the one single common shaft 300. The first and second motor position sensors 140 and 240 may be disposed in sensing relationship with the one single common shaft 300. For example, the first motor position sensor 140 and the second motor position sensor 240 may be positioned adjacent or around the one single common shaft 300. The first motor position sensor 140 and the second motor position sensor 240 can detect or sense angular positions of the first motor assembly 100 and the second motor assembly 200, respectively, (such as the pulley 310 or the one single common shaft 300) in a single-turn range which is a range of zero to three hundred sixty degrees (0-360°). The first motor position sensor 140 and the second motor position sensor 240 may generate output signals indicative of the sensed angular positions of the one single common shaft 300.

The first motor position sensor 140 and the second motor position sensor 240 can be any suitable device(s) for generating signal responsive to the rotation of the one single common shaft 300. For example, the first motor position sensor 140 and the second motor position sensor 240 may be an inductive sensor, a magnetic sensor (e.g. a Hall effect sensor), a magnetoresisitve (MR) sensor, or any other sensor known in the art with similar capabilities.

The inductive sensor may be a sensor configured to operate based on the principle of electromagnetic induction to detect or measure nearby metallic objects. An inductor develops a magnetic field when an electric current flows through it. Alternatively, a current will flow through a circuit containing an inductor when the magnetic field through it changes. This effect can be used to detect metallic objects that interact with a magnetic field. For example, the inductive sensor according to an embodiment of the present disclosure may utilize aspects described in U.S. patent application Ser. No. 18/930,897, entitled “INDUCTIVE SENSOR SYSTEM COMPRISING INDUCTIVE TORQUE AND POSITION SENSOR ASSEMBLIES”, filed on which is hereby incorporated herein by reference in its entirety. In an embodiment for an inductive sensor, an excitation or transmitter coil set configured to generate an electromagnetic field over the one single common shaft 300 and a receiver coil set configured to detect the electromagnetic field around the one single common shaft 300 may be included in or mounted to the first circuit board 130 or the second circuit board 230, and a target having a metallic pattern or one or more conductive loops configured to affect the electromagnetic field generated by the excitation or transmitter coil set may be included in or attached to the one single common shaft 300.

In an embodiment for a magnetic sensor (e.g. a Hall effect sensor), the one single common shaft 300 may include a magnetic gradient formed on a surface of the one single common shaft 300 defined by a plurality of alternating north and south magnetically charged elements circumferentially spaced about the circumference of the one single common shaft 300. The magnetic sensor configured to sense or detect the magnetic field around the one single common shaft 300 may be included in or mounted to the first circuit board 130 or the second circuit board 230.

The first motor position sensor 140 and the second motor position sensor 240 are electrically connected with the first circuit board 130 and the second circuit board 230, respectively.

In a first embodiment, both the first motor position sensor 140 and the second motor position sensor 240 may be an inductive sensor to reduce the size of the single package 400 and lower manufacturing cost. In a second embodiment, one of the first motor position sensor 140 and the second motor position sensor 240 may be an inductive sensor and the other of the first motor position sensor 140 and the second motor position sensor 240 may be a magnetic sensor. In a third embodiment, the first motor position sensor 140 as well as the second motor position sensor 240 may be a magnetic sensor.

A linear position sensor 640 is configured to sense a linear position of the steering rack 36. The linear position sensor 640 may be electrically connected to the first circuit of the first motor assembly 100 and/or the second circuit of the second motor assembly 200 and output electrical signals indicative of the linear position of the steering rack 36.

In an embodiment of FIG. 2, only one belt 350 is coupled to the one single common shaft 300 and the rotary-to-linear conversion mechanism 500.

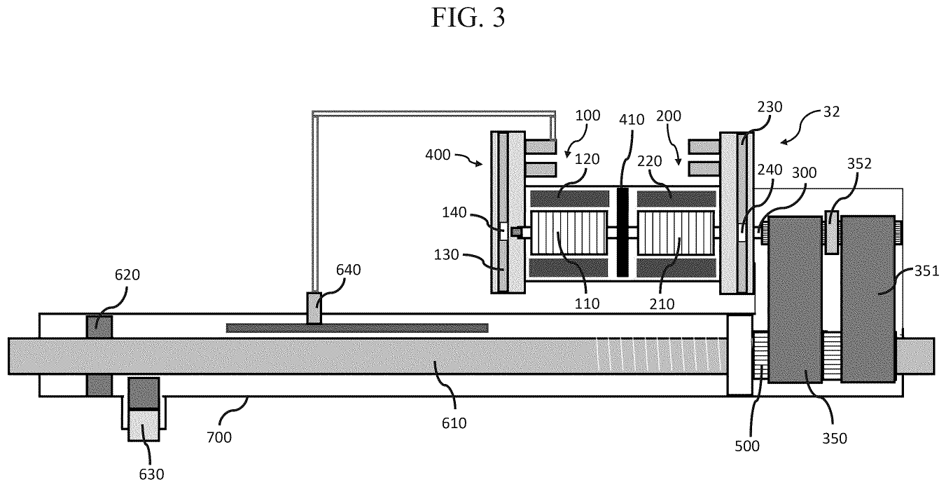

Alternatively, as illustrated in an embodiment of FIG. 3, dual belts including the first belt 350 and the second belt 351 can couple the one single common shaft 300 and the rotary-to-linear conversion mechanism 500. Even if one of the first and second belts 350 fails, the other of the first and second belts 350 which normally operates can transfer the rotary force of the one single common shaft 300 to the rotary-to-linear conversion mechanism 500. The first belt 350 and the second belt 351 are arranged in parallel with each other. A flange 352 may be located between the first belt 350 and the second belt 351 such that the first belt 350 and the second belt 351 are positioned to be spaced apart from each other in order to maintain the first belt 350 and the second belt 351 in place and prevent from interfering each other.

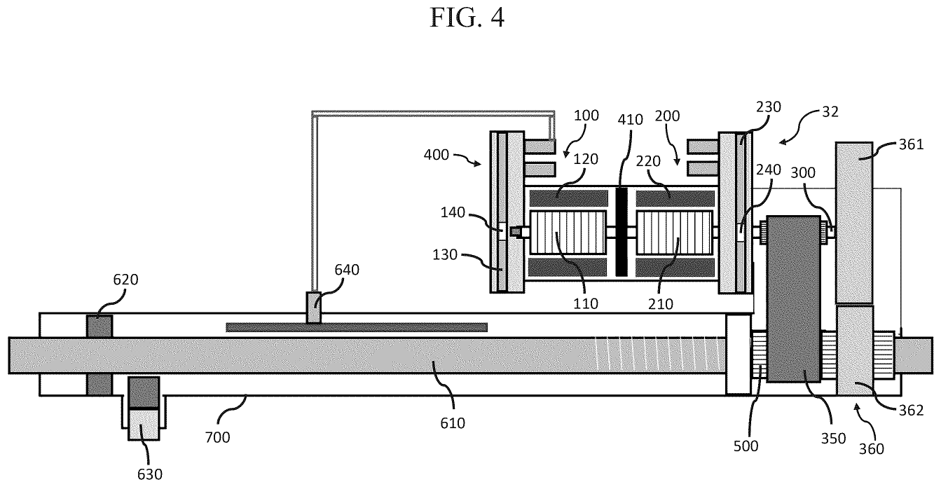

In another embodiment of FIG. 4, a back-up gear assembly 360 may be included in addition to the belt 350. The back-up gear assembly 360 may comprise a first gear 361 coupled to the one single common shaft 300 and a second gear 362 coupled to the rotary-to-linear conversion mechanism 500. In a state that the belt 350 does not fail (e.g. when the belt 350 appropriately connects the one single common shaft 300 and the rotary-to-linear conversion mechanism 500 and is able to transfer the rotary torque to the rotary-to-linear conversion mechanism 500), clearance between teeth of the first gear 361 and teeth of the second gear 362 can be maintained. For instance, one of teeth of the first gear 361 and teeth of the second gear 362 is smaller or narrower than the other of teeth of the first gear 361 and teeth of the second gear 362 to provide clearance between teeth of the first gear 361 and teeth of the second gear 362. However, when the belt 350 fails (e.g. the belt 350 is loosened or broken), the teeth of the second gear 362 is contacted by or engaged with the teeth of the first gear 361 so that the rotation of the first gear 361 can cause the second gear 362 to rotate, and therefore the rotation torque of the one single common shaft 300 can be transferred to the rotary-to-linear conversion mechanism 500 even when the belt 350 fails.

Although the example embodiments have been described in detail, it should be understood that various changes, substitutions and alterations can be made herein without departing from the spirit and scope of the application as defined by the appended claims.

Moreover, the scope of the present application is not intended to be limited to the particular embodiments of the process, machine, manufacture, and composition of matter, means, methods and steps described in the specification. As one of ordinary skill in the art will readily appreciate from the disclosure, processes, machines, manufacture, compositions of matter, means, methods or steps, presently existing or later to be developed, that perform substantially the same function or achieve substantially the same result as the corresponding embodiments described herein may be utilized according to the embodiments and alternative embodiments. Accordingly, the appended claims are intended to include within their scope such processes, machines, manufacture, compositions of matter, means, methods, or steps.

What is claimed is:

1. A steer-by-wire system comprising:
first and second motor assemblies having one common shaft operably coupled to a steering rack; and
the steering rack configured to be linearly movable in response to rotation of the one common shaft of the first and second motor assemblies.

2. The steer-by-wire system of claim 1, wherein:
the first motor assembly comprises a first rotor, a first stator, and a first circuit,
the second motor assembly comprises a second rotor, a second stator, and a second circuit, and
both the first rotor of the first motor assembly and the second rotor of the second motor assembly are fixedly coupled to the one common shaft operably coupled to the steering rack.

3. The steer-by-wire system of claim 1, further comprising a single package having an inside space accommodating the first and second motor assemblies,
wherein a seal is positioned between the first motor assembly and the second motor assembly in the inside space of the single package.

4. The steer-by-wire system of claim 1, further comprising a rotary-to-linear conversion mechanism operably connected between the one common shaft of the first and second motor assemblies and the steering rack and configured to convert a rotational motion of the one common shaft of the first and second motor assemblies into a linear motion for linearly moving the steering rack.

5. The steer-by-wire system of claim 4, further comprising a belt rotatably coupled to the one common shaft of the first and second motor assemblies and the rotary-to-linear conversion mechanism.

6. The steer-by-wire system of claim 4, further comprising at least two belts arranged in parallel with each other and coupled to the one common shaft of the first and second motor assemblies and the rotary-to-linear conversion mechanism.

7. The steer-by-wire system of claim 6, further comprising a flange between the at least two belts coupled to the one common shaft of the first and second motor assemblies such that the at least two belts are positioned to be spaced apart from each other.

8. The steer-by-wire system of claim 4, further comprising a belt and a first gear coupled to the one common shaft of the first and second motor assemblies.

9. The steer-by-wire system of claim 4, further comprising a second gear configured to maintain clearance between teeth of the first gear and teeth of the second gear in a state that the belt does not fail, and to be engaged with the first gear to be rotated by the first gear coupled to the one common shaft of the first and second motor assemblies in a state that the belt fails.

10. The steer-by-wire system of claim 1, wherein:
the first motor assembly comprises a first inductive motor position sensor configured to sense an angular position of a first motor of the first motor assembly, and
the second motor assembly comprises a second inductive motor position sensor configured to sense a position of a second motor of the second motor assembly.

11. The steer-by-wire system of claim 1, wherein:
the first motor assembly comprises a first inductive motor position sensor configured to sense an angular position of a first motor of the first motor assembly, and
the second motor assembly comprises a second magnetic motor position sensor configured to sense a position of a second motor of the second motor assembly.

12. The steering-by-wire system of claim 2, further comprising a linear position sensor configured to sense a linear position of the steering rack and connected to one or both of the first circuit of the first motor assembly and the second circuit of the second motor assembly.

13. The steering-by-wire system of claim 2, wherein the first rotor and the first stator of the first motor assembly and the second rotor and the second stator of the second motor assembly are disposed between the first circuit of the first motor assembly and the second circuit of the second motor assembly.

14. The steering-by-wire system of claim 3, wherein:
the first rotor and the first stator of the first motor assembly are disposed between the seal and between the first circuit of the first motor assembly, and
the second rotor and the second stator of the second motor assembly are disposed between the seal and between the second circuit of the second motor assembly.

15. A steer-by-wire system comprising:
first and second motor assemblies having one common shaft;
a single package having an inside space accommodating the first and second motor assemblies;
a steering rack configured to be linearly movable in response to rotation of the one common shaft of the first and second motor assemblies; and
a rotary-to-linear conversion mechanism operably connected between the one common shaft of the first and second motor assemblies and the steering rack and configured to convert a rotary motion of the one common shaft of the first and second motor assemblies into a linear motion for linearly moving the steering rack.

16. The steer-by-wire system of claim 15, wherein:
the first motor assembly comprises a first rotor, a first stator, and a first circuit,
the second motor assembly comprises a second rotor, a second stator, and a second circuit, and
the first rotor of the first motor assembly and the second rotor of the second motor assembly are fixedly coupled to the one common shaft operably coupled to the steering rack.

17. The steer-by-wire system of claim 15, wherein a seal is positioned between the first motor assembly and the second motor assembly in the inside space of the single package.

18. The steer-by-wire system of claim 15, further comprising a belt rotatably coupled to the one common shaft of the first and second motor assemblies and the rotary-to-linear conversion mechanism.

19. The steer-by-wire system of claim 15, further comprising at least two belts arranged in parallel with each other and coupled to the one common shaft of the first and second motor assemblies and the rotary-to-linear conversion mechanism.

20. The steer-by-wire system of claim 18, further comprising comprises:
a belt and a first gear coupled to the one common shaft of the first and second motor assemblies; and
a second gear configured to maintain clearance between teeth of the first gear and teeth of the second gear in a state that the belt does not fail, and to be engaged with the first gear to be rotated by the first gear coupled to the one common shaft of the first and second motor assemblies in a state that the belt fails.
